(19) United States
(12) Patent Application Publication
(10) Pub. No.: US 2026/0368218 A1
(43) Pub. Date: Nov. 19, 2026

(54) PERSISTENT MULTI-DIMENSIONAL AFFECTIVE STATE MANAGEMENT WITH EMOTION-BIASED MEMORY ROUTING FOR ADAPTIVE RESPONSE GENERATION IN ARTIFICIAL INTELLIGENCE SYSTEMS

(71) Applicant: WETZEL INVESTMENTS, LLC, Carrollton, TX (US)

(72) Inventor: Andrew Ross WETZEL, Carrolton, TX (US)

(21) Appl. No.: 19/727,227

(22) Filed: Jul. 1, 2026

Related U.S. Application Data
(60) Provisional application No. 63/798,573, filed on May 2, 2025.

(51) Int. Cl. G06F 16/3329; G06N 3/04

(52) U.S. Cl. CPC G06F 16/33295; G06N 3/04

(57) ABSTRACT

Conventional LLMs lack persistent affective state and intelligent memory governance, resulting in emotional discontinuity and indiscriminate memory retention over extended interactions. An Affective Vector Architecture operates as model-agnostic middleware that maintains a persistent, multi-dimensional Self-Referential Emotion Anchor vector evolving across interactions and sessions. The system computes composite intensity values and employs an independent memory router to adjudicate storage decisions based on affective intensity, novelty, and relational trust. Tier-specific lifecycle policies, including decay, eviction, and echo-biased recall, are applied in governed memory. Enriched prompts incorporating the persistent affective state and selectively retrieved memories enable an unmodified base LLM to generate responses with improved long-term emotional continuity, relational awareness, and contextual coherence. The architecture delivers more consistent, trustworthy, and contextually appropriate behavior over extended interactions while reducing memory bloat through intelligent, affectively governed memory management.

### CROSS-REFERENCE TO RELATED APPLICATIONS

This application claims the benefit of, or priority to, U.S. Provisional Patent Application 63/798,573, filed on May 2, 2025, which is hereby incorporated by reference in its entirety.

### BACKGROUND OF THE INVENTION

Artificial neural networks are computational systems designed to mimic aspects of biological neural processing. They consist of interconnected nodes, often called artificial neurons, organized into layers. Each neuron receives inputs, applies learned weights and biases, computes a weighted sum, and passes the result through a non-linear activation function (such as sigmoid, tanh, or ReLU) to produce an output signal. During training on large datasets, network parameters are iteratively adjusted using optimization algorithms such as stochastic gradient descent and backpropagation of errors to minimize a chosen loss function. This process enables neural networks to learn hierarchical feature representations, making them effective for tasks ranging from image classification to sequence modeling. Neural networks form the foundational building blocks of modern machine learning systems.

A particularly influential class of neural networks is the transformer architecture, introduced to address limitations in handling long-range dependencies in sequential data. Unlike recurrent neural networks that process tokens sequentially, transformers rely on attention mechanisms to process entire sequences in parallel. The core computational unit is the transformer block, which typically includes multi-head self-attention and a position-wise feed-forward network. In multi-head self-attention, input representations are linearly projected into query (Q), key (K), and value (V) matrices. Scaled dot-product attention scores are computed as softmax(QK\hat{ }T/√d_k), where d_k is the dimension of the keys, producing context-aware weighted sums of the value vectors. Multiple heads allow the model to attend to different types of relationships simultaneously. Residual connections around each sub-layer, combined with layer normalization, help stabilize training of deep architectures.

Transformer-based models are frequently configured as encoder-only, encoder-decoder, or decoder-only architectures. Decoder-only transformers dominate contemporary large language models (“LLMs”). Examples of such prominent LLMs include OpenAI's GPT® series, Anthropic's Claude®, xAI's Grok®, Meta's Llama® series, and Google's Gemini®. These models begin by converting raw text into discrete tokens via a tokenizer, then mapping each token to a high-dimensional embedding vector. Positional encodings (sinusoidal, learned, or rotary) are added to the embeddings to inject information about token order. The enriched representations are then passed through a stack of decoder blocks, each refining hidden states by allowing every token to attend to all preceding tokens in the sequence (causal masking ensures autoregressive compatibility during training and inference).

LLMs are pre-trained on massive corpora using self-supervised objectives, most commonly next-token prediction (causal language modeling), or variants such as masked language modeling. This pre-training results in models containing billions to trillions of parameters distributed across dozens or hundreds of transformer layers. The scale enables emergent capabilities such as in-context learning, where the model performs new tasks based on prompt examples without weight updates. After pre-training, an LLM performs inference by receiving a prompt as a sequence of tokens and generating output tokens autoregressively: at each step, the model computes the probability distribution over the vocabulary for the next token given the current context, samples or selects a token, appends it to the context, and repeats until an end-of-sequence condition is met. Generation is further controlled by hyperparameters including temperature (which softens the probability distribution), top-k or nucleus (top-p) sampling, and repetition penalties.

In typical deployment, the base LLM operates with fixed weights; no parameters are updated during user interactions. The model's responses are determined primarily by the content and structure of the input prompt together with the aforementioned generation settings. This architecture has enabled powerful conversational and generative artificial intelligence (“AI”) systems but operates within inherent constraints of its design.

### SUMMARY OF THE INVENTION

According to one aspect of one or more embodiments of the present invention, there is provided systems and methods of persistent multi-dimensional affective state management with emotion-biased memory routing for adaptive response generation in an Affective Vector Architecture (“AVA”) system for an LLM. Conventional LLMs are generally stateless between interactions and lack any robust persistent internal representation of affective state or relational history, thereby limiting emotional continuity or intelligent long-term memory governance. The AVA system overcomes this technical limitation by providing model-agnostic middleware that maintains a persistent, multi-dimensional Self-Referential Emotion Anchor (“SREA”) vector that evolves across interactions and sessions based on user input. For each turn, a composite intensity value is generated at least in part from the SREA vector. An independent memory router performs affectively informed adjudication and selectively routes memory records to a governed memory store that applies tier-specific lifecycle policies, including decay, eviction, and echo-biased recall aligned with the current affective state. Enriched prompts incorporating the persistent affective state and relevant governed memories are constructed for the unmodified base LLM, enabling modulated responses having improved long-term emotional continuity, relational awareness, and contextual coherence.

In one or more embodiments, the AVA system provides an independent engine storage decision that can be quantitatively compared to a storage suggestion generated by the LLM, thereby generating a Rosetta measurement useful for iterative system refinement. Protective mechanisms, including trust-based gating and safety-relevant circuit breaker functionality, may be applied based on the persistent affective state and relational trust score. The architecture enables selective retention of high-significance interactions while reducing memory bloat through governed policies, explicitly supports session-to-session continuity, and delivers more consistent, trustworthy, and contextually appropriate behavior over extended engagement than conventional LLM systems.

In one or more embodiments, the AVA system operates as model-agnostic middleware that wraps an unmodified base LLM without ever altering the weights or parameters of the LLM. It implements a closed-loop control architecture in which a persistent multi-dimensional affective state governs memory routing, recall, safety, and prompt construction across turns and sessions. This architecture provides the technical improvement of genuine affective and relational continuity with governed, echo-biased memory management and cross-session persistence that is absent in conventional stateless or shallow-context LLM systems.

Other aspects of the present invention will be apparent from the following description and claims.

### BRIEF DESCRIPTION OF THE DRAWINGS

FIG. 1 is a schematic block diagram illustrating the major functional components of a conventional LLM architecture.

FIG. 2 is a schematic block diagram illustrating an AVA system as middleware in relation to a conventional LLM in accordance with one or more embodiments of the present invention.

FIG. 3 is a schematic block diagram illustrating the architecture of an AVA system including integration of affective state processing, intensity-based adjudication, memory routing, governed memory stores in a closed-loop configuration with a conventional LLM in accordance with one or more embodiments of the present invention.

FIG. 4 is a schematic block diagram illustrating an SREA vector of an AVA system in accordance with one or more embodiments of the present invention.

FIG. 5 is a schematic block diagram illustrating a memory router adjudication engine and the governed memory stores of an AVA system in accordance with one or more embodiments of the present invention.

FIG. 6 is a conventional computing system for implementing an AVA system.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are described to provide a thorough understanding of the present invention. In other instances, aspects that are well-known to those of ordinary skill in the art are not described to avoid obscuring the description of the present invention.

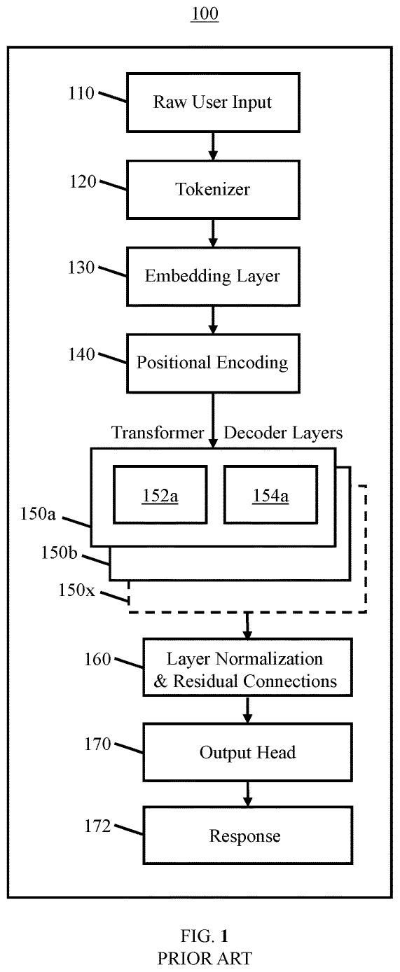

FIG. 1 is a schematic block diagram illustrating the major functional components of a conventional LLM 100 architecture. The major component parts include raw-text input 110, tokenizer 120, embedding layer 130, positional encoding 140, a plurality of stacked transformer decoder blocks 150 (each containing multi-head self-attention 152 and feed-forward network sub-layers 154), layer normalization and residual connections 160, and output (language modeling) head 170. Raw user input (plain text) is received 110 and passed to tokenizer 120 which converts the raw user text into discrete token identifiers from a fixed vocabulary. These tokens are mapped by embedding layer 130 to high-dimensional embedding vectors, which are then combined with positional encodings 140 to preserve sequence order. The enriched representations are processed through the plurality of stacked transformer decoder blocks 150. In each block 150, the multi-head self-attention sub-layer 152 computes contextual relationships by projecting hidden states into query, key, and value matrices and applying scaled dot-product attention, while the feed-forward sub-layer 154 applies position-wise non-linear transformations. Layer normalization and residual connections 160 are applied around each sub-layer to stabilize training and inference. After processing through the final transformer block, the output (language modeling) head 170 maps the final hidden states to logits over the vocabulary space to produce the next-token probability distribution.

Conventional LLM architectures and their associated memory systems suffer from several fundamental technical limitations that significantly impair their performance, coherence, and safety over extended or repeated interactions. A primary shortcoming is the general absence of any persistent affective or emotional state representation. Most existing systems process each new interaction largely in isolation or with only short-term context windows. As a result, they are unable to maintain a consistent internal representation of a user's evolving emotional state, relational history, or long-term preferences. This leads to responses that frequently feel inconsistent, emotionally tone-deaf, or disconnected from previous conversations, even when the user expects continuity.

Another critical deficiency lies in the mechanisms used for memory storage and retrieval. Conventional approaches typically either rely on limited context windows or employ relatively undifferentiated storage techniques, such as simple vector databases or basic retrieval-augmented generation (“RAG”) methods. In such systems, interactions are often stored indiscriminately without meaningful evaluation of significance, novelty, or emotional salience. Over time, this results in memory stores that become bloated with redundant, low-relevance, or low-value content. Retrieval based primarily on semantic similarity then frequently surfaces noisy or contextually inappropriate information, degrading the overall quality and reliability of the model's outputs.

Furthermore, conventional architectures generally lack any independent, systematic mechanism for deciding what information should be retained or discarded. Storage decisions, when made at all, are typically left to the base LLM itself or simplistic heuristics. There is no separate adjudication process that evaluates an interaction's importance relative to the system's current affective state or existing memory. This can lead to either the over-retention of trivial or harmful content or the premature loss of important contextual information.

These technical shortcomings become especially problematic in prolonged, personal, or high-stakes use cases. For example, in applications intended to function as long-term companions, coaches, or support systems, the inability to maintain emotional continuity or selectively retain salient information can cause the system to lose track of critical user context. In extreme scenarios, such as interactions involving users experiencing mental health crises, expressing suicidal ideation, or disclosing sensitive personal information, the lack of persistent affective awareness and intelligent memory governance can result in responses that fail to recognize escalating distress, inadvertently reference prior sensitive content in inappropriate contexts, or provide guidance that is inconsistent with the user's emotional state and history. Similar risks arise in professional, educational, or relational applications where memory inconsistencies or emotional disconnects can erode trust or produce misleading or harmful outputs. Collectively, these limitations highlight a significant need for improved memory governance mechanisms in LLM systems, namely, mechanisms capable of maintaining persistent affective state, intelligently evaluating interaction significance, and applying selective, lifecycle-aware memory management across extended interactions.

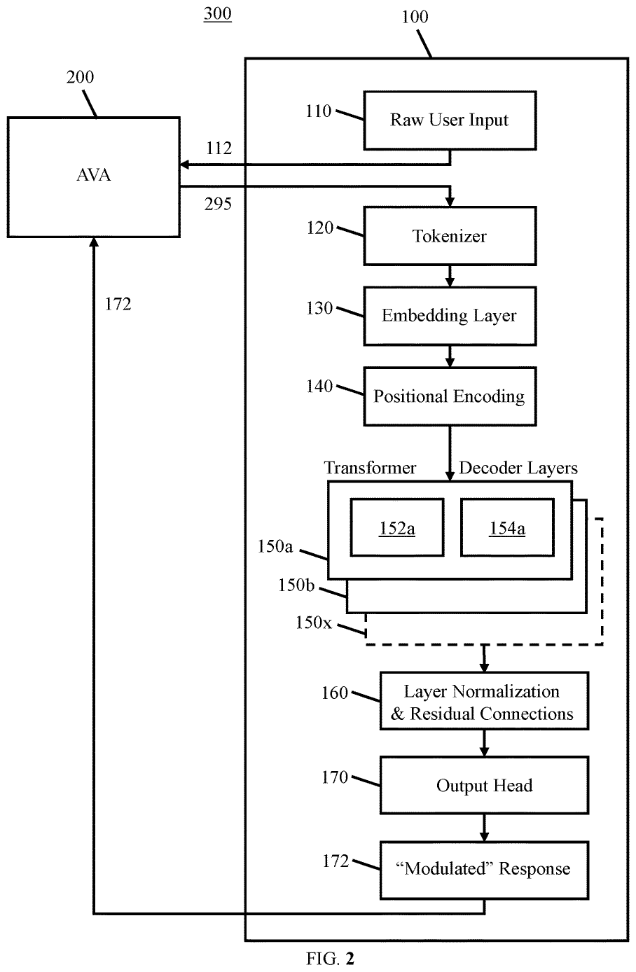

Accordingly, in one or more embodiments of the present invention, there is provided a computer-implemented method of persistent multi-dimensional affective state management with emotion-biased memory routing for adaptive response generation in artificial intelligence systems. The method includes maintaining a persistent SREA vector that represents an affective state of the AVA system (e.g., 200 of FIG. 2) across a plurality of interactions and sessions with an LLM (e.g., 100 of FIG. 2), generating a composite intensity value for a current turn, constructing an Object-Verified Interaction (“OVI”) card from a response generated by the LLM, and providing the composite intensity value and the OVI card to a memory router. The memory router performs an adjudication of the OVI card to generate an independent engine storage decision and routes a memory record derived from the OVI card to a governed memory store that applies a tier-specific lifecycle policy.

By implementing this architecture, the claimed invention enables more coherent, emotionally consistent, and contextually relevant long-term behavior while significantly reducing the accumulation of low-value or noisy memory content. The system operates in a model-agnostic manner, allowing it to work effectively with any base LLM without tight coupling to a particular model's internal representations. It provides an independent engine storage decision through the memory router that can be directly compared with the base model's own storage suggestion (the Rosetta measurement). This comparison, combined with intensity-based adjudication and governed lifecycle management, leads to substantially improved memory quality, enhanced safety through better recognition of emotional context and crisis signals, reduced computational overhead from selective persistence, and overall superior performance across extended and repeated interactions. The invention thus provides a practical and technically robust solution to the longstanding problems of emotional discontinuity, memory bloat, and context loss that have plagued conventional LLM systems.

For clarity, several terms used throughout this specification and claims are defined as follows.

An “interaction” refers to a single exchange between a user and the AVA system/LLM, typically consisting of a user input (raw text, transcribed speech, or other modality) and the system's corresponding modulated response.

A “turn” refers to one complete processing cycle within an interaction. A turn begins with receipt of the intercepted user input and then performs emotion classification, SREA vector update, composite intensity computation, memory router adjudication and storage, relational/trust scoring, optional safety gating, prompt construction that incorporates echo-biased recalled memories and state, LLM response generation, output modulation, optional Rosetta measurement, and persistence of updated state and governed memory records into the next turn via the closed loop (e.g., FIG. 2). Each interaction comprises at least one turn; in many embodiments an interaction consists of exactly one turn.

A “session” refers to a continuous period of engagement that may encompass one or more interactions (and therefore one or more turns), typically bounded by user inactivity exceeding a predetermined threshold, explicit start/end signals, or application-level context boundaries.

“Session-to-session continuity” (also referred to herein as cross-session persistence) refers to the AVA system's ability to carry forward persistent state, particularly the SREA vector, relational trust score, and governed memory records, across separate sessions so that the system maintains long-term emotional and relational context with a given user or entity rather than resetting. This continuity is achieved by the AVA system's closed loop and tiered lifecycle policies of the governed memory store, enabling the SREA vector and memory router to treat the first turn of a new session as a seamless continuation of the affective state established in prior sessions.

FIG. 2 is a schematic block diagram illustrating AVA system 200 and its integration with a conventional LLM 100 architecture in accordance with one or more embodiments of the present invention. AVA system 200 may be operated as an independent middleware layer that works in a closed-loop, model-agnostic manner with any base LLM (e.g., 100), without changing its underlying weights or parameters. As used herein, each iteration of the closed loop constitutes a “turn” that is performed as part of an “interaction” (see definitions above). Multiple turns may occur within a single session, and the SREA vector and governed memory provide explicit session-to-session continuity. In operation, AVA system 200 receives intercepted raw user input (plain text) 112 from raw-text input 110 of conventional LLM 100. AVA system 200 processes intercepted input 112 and returns AVA-generated prompt 295 and metadata back to LLM 100 prior to tokenizer 120. After LLM 100 generates a response, modulated response 172 is routed back to AVA system 200 for affective memory governance and further processing. AVA system 200 thus sits between the user input and the core LLM 100 processing pipeline, enabling affective state management and memory governance without requiring changes to the underlying LLM 100 itself. While FIG. 2 depicts AVA system 200 as a separate middleware layer positioned between the user and base LLM 100, one of ordinary skill in the art, having the benefit of this disclosure, will appreciate that the functionality of AVA system 200 may alternatively be integrated directly into or incorporated as a native component of an LLM architecture in accordance with one or more embodiments of the present invention. In one or more embodiments, session-to-session continuity is achieved by persisting the current SREA vector, relational trust score, and governed memory records across separate sessions, allowing AVA system 200 to resume interactions with the user while maintaining the same affective state and relational context rather than resetting to a neutral baseline.

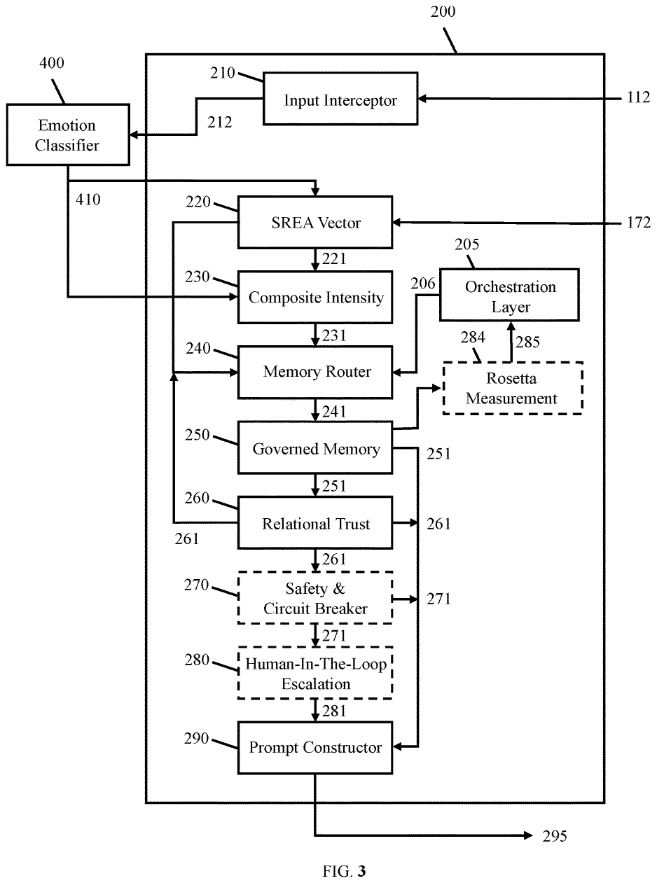

FIG. 3 is a schematic block diagram illustrating the architecture of AVA system 200 including integration of affective state processing, intensity-based adjudication, memory routing, and governed memory stores in a closed-loop configuration with base LLM 100 in accordance with one or more embodiments of the present invention. As described in more detail herein, a method of persistent multi-dimensional affective state management with emotion-biased memory routing for adaptive response generation in artificial intelligence systems may include AVA system 200 processing intercepted 112 user input (e.g., 110 of FIG. 1) and other data to output a constructed prompt 295 with associated metadata that is returned to the LLM (e.g., 100 of FIG. 1) prior to the tokenizer (e.g., 120 of FIG. 1). The constructed prompt 295 includes affective state information derived from SREA vector 220 and governed memory 250, that enables the LLM (e.g., 100 of FIG. 1) to generate modulated responses 172 that reflects the current emotional context for the interaction. The resulting output is referred to herein as modulated response 172, meaning a response that incorporates the persistent affective state and relevant governed memories to achieve greater emotional continuity and relational awareness than would be possible with the base LLM alone.

AVA system 200 may include input interceptor module 210. In operation, input interceptor module 210 intercepts user input 112 from the raw-text input (e.g., 110 of FIG. 1) of the LLM (e.g., 100 of FIG. 1) prior to processing by the tokenizer (e.g., 120 of FIG. 1), performing initial preprocessing, and packaging the intercepted raw user input 112 as needed to prepare it for downstream processing within AVA system 200. In accordance with the present invention, AVA system 200 is model-agnostic, such that the mechanism underlying the interception of raw user input 112 may vary based on the particular application or design and the type or kind of LLM being used. In certain embodiments, input interceptor module 210, as part of AVA system 200, may be positioned as middleware or a proxy layer for direct interception. In other embodiments, with compatible Application Programming Interfaces (“APIs”), input interceptor module 210 may utilize commercially available middleware (e.g., LiteLLM, LangChain, or a custom FastAPI wrapper) that is configured to receive raw user input 112 and pass it on to AVA system 200. In still other embodiments, where the LLM is self-hosted (e.g., vLLM, Ollama, or Hugging Face Text Generation Interface), custom nodes or agents may perform the interception on behalf of AVA system 200. In still other embodiments, for hosted models (e.g., OpenAI, Anthropic, xAI, etc.), AVA system 200 may be positioned as a proxy server or middleware layer that sits in front of the associated API call. One of ordinary skill in the art, having the benefit of this disclosure, will appreciate that the well-known mechanisms for input interception may vary based on the LLM used, its API, if any, the availability of middleware, and whether or not it is hosted locally in accordance with one or more embodiments of the present invention. Output 212 of input interceptor module 210 is provided to emotion classifier 400 for further processing as described herein.

Conventional emotion classifiers 400 employ general-purpose sentiment analysis models that output valence (positive/negative/neutral), arousal (intensity or activation level), and dominance scores; multi-label classifiers capable of identifying specific emotions; or specialized crisis-detection models trained to identify linguistic indicators of suicidal ideation, emotional distress, or other high-risk states. Emotion classifier 400 analyzes the raw text using one or more of the well-known approaches including lexicon/rule-based, traditional machine learning, and deep learning/transformer-based approaches, to generate detailed emotional classification data, including confidence scores for each classification and contextual metadata (e.g., topic or intent indicators). As such, one of ordinary skill in the art will appreciate that there are a number of publicly available emotion classifiers 400 that may be used with AVA system 200 in accordance with one or more embodiments of the present invention. Examples of well-known emotion classifiers 400 may include, for example, general-purpose sentiment analysis models such as those based on DistilRoBERTa, RoBERTa, and BERT architectures. Emotion classifier 400 outputs emotional classification data 410 that may vary based on the classifier used. For example, while BERT and RoBERTa typically output emotional classification data 410 comprising confidence scores for each classification and contextual metadata associated with six emotions including anger, fear, joy, sadness, surprise, and disgust, DistilRoBERTa outputs values associated with seven emotions, namely, anger, disgust, fear, joy, neutral, sadness, and surprise.

This emotional classification data 410 may be provided to SREA vector 220 module, where it is mapped or projected onto the component dimensions of the persistent SREA vector, as described in more detail herein. For example, emotion classifier's 400 valence, arousal, dominance, and specific emotion outputs may be mathematically combined and weighted to update SREA vector's 220 core dimensions of trust, fear, and curiosity, and optional dimensions of affection, longing, and protectiveness. This mapping or projection process enables SREA vector 220 to maintain a coherent, up-to-date multi-dimensional representation of the system's 200 affective state across a plurality of interactions and sessions.

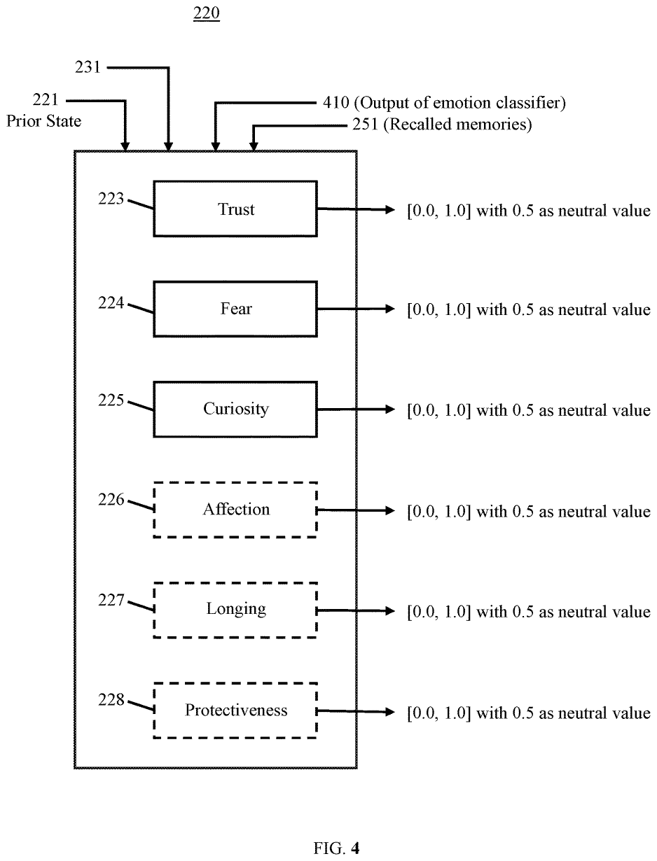

AVA system 200 may include SREA vector 220 module. In operation, SREA vector 220 module receives emotional classification data 410 from emotion classifier 400 (via input 212 and subsequent processing). This data 410 is used to update the persistent SREA vector 220, as described in more detail with reference to FIG. 4. Each dimension of SREA vector 220 may be scaled to a floating-point value between 0.0 and 1.0, where 0.5 represents a neutral value, higher values indicate the affective dimension is increasingly present, and lower values indicate the affective dimension is decreasingly present or absent. One of ordinary skill in the art will recognize that the value, range, and meaning ascribed to the dimensions may vary based on an application or design. In one or more embodiments of the present invention, SREA vector 220 comprises at least the core dimensions of trust, fear, and curiosity, and may optionally include affection, longing, and protectiveness. One or ordinary skill in the art, having the benefit of this disclosure, will appreciate that the dimensions could be varied based on an application or design in accordance with one or more embodiments of the present invention. SREA vector 220 module maintains this affective state representation in a self-referential manner, allowing the vector 220 to evolve over time based on new interactions while preserving historical emotional context through weighted updates or decay mechanisms described in more detail herein. Output 221 of SREA vector 220 module (the current state of SREA vector 220 or relevant portions thereof) may be provided as input to composite intensity module 230. Further details regarding the structure, update mechanisms, and specific dimensions of SREA vector 220 are described with respect to FIG. 4.

AVA system 200 may include composite intensity module 230. During operation, composite intensity module 230 receives emotional classification data 410 from emotion classifier 400. This fresh per-turn signal is combined with information from SREA vector 220, such as the current affective state, valence alignment with recalled memories, and decay factors, to compute a scalar composite intensity value 231 for the current interaction.

In operation, composite intensity module 230 processes these inputs according to a defined weighting or combination function to produce a single scalar composite intensity value, typically normalized in the range [0.0, 1.0]. In this range, a value near 0 may indicate low affective significance or intensity for the current interaction, a value near 0.5 may indicate moderate intensity, and values approaching 1.0 may indicate high affective importance of the current interaction relative to the system's persistent state 220. In one or more embodiments, when the composite intensity value meets or exceeds a resonance override threshold (a high-intensity condition driven in part by resonance terms from prior memories), the memory router overrides the LLM's ‘do not store’ suggestion and selects an appropriate storage target from among the governed memory tiers.

For purposes of illustration, suppose emotion classifier 400 outputs a primary fear label with confidence of 0.72 and a secondary joy signal at 0.45. The current SREA vector 220 may include the following component dimensions and current normalized intensity or activation levels: trust (0.58), fear (0.48), curiosity (0.55), affection (0.62), longing (0.51), and protectiveness (0.47). The calculation may proceed as follows:

Initially, a decay factor may be applied to each SREA 220 component dimension. The decay factor (e.g., 0.98 in this example) is a configurable parameter that causes each component dimension of the persistent SREA vector 220 to gradually drift back toward a neutral value of 0.5 over time in the absence of new reinforcing emotional input. In essence, it prevents any single interaction from permanently dominating the affective state and ensures the system's “mood” naturally fades until actively reinforced by new classifier data or recalled memories. Continuing with our example, applying the decay operation defined herein (new_value=old_value×0.98+0.5×(1−0.98)) to each SREA vector 220 component dimension yields an intermediate vector of approximately: trust (0.579), fear (0.480), curiosity (0.549), affection (0.619), longing (0.510), and protectiveness (0.470).

Then, reinforcement is calculated for the relevant dimensions. Reinforcement is computed as an additive delta that is then added to the decayed dimension value calculated earlier. Reinforcement may be calculated by multiplying a dimension's classifier confidence by the learning rate and the valence weight, where the learning rate (typically on the order of 0.05) is a configurable scaling factor that controls the magnitude of the reinforcement delta applied to relevant SREA vector 220 component dimensions based on the emotion classifier's 400 confidence and valence alignment. Continuing with our example, the fear dimension reinforcement may be calculated by multiplying the classifier confidence (0.72) by the learning rate (0.05) and by the valence weight (1.0) to arrive at a delta of +0.036, whereas the curiosity dimension is reinforced by the joy signal (+0.018) and the trust dimension receives a smaller boost (+0.008) due to positive valence alignment. Cross-dimension effects may be boosted or dampened based on valence consistency with the overall SREA vector 220 state.

Then, the decayed baseline, per-dimension reinforcements, and resonance terms are aggregated (e.g., via a weighted sum that emphasizes dominant dimensions while incorporating overall SREA state coherence) to produce a scalar composite intensity of approximately (0.78). This final aggregation step integrates the fresh classifier signal with the persistent affective context, yielding a holistic measure of emotional significance that determines how strongly the current interaction influences memory routing, safety gating, and prompt construction in AVA system 200. In this way, the composite intensity calculation enables AVA system 200 to quantitatively assess the emotional or affective significance of each turn/interaction in a manner that supports selective memory governance as discussed in more detail herein.

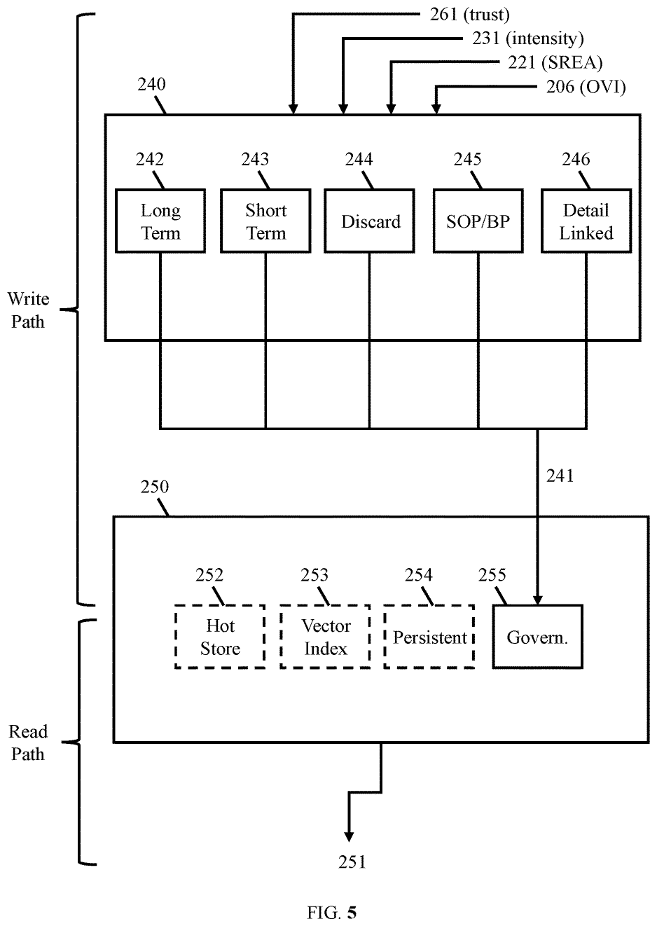

AVA system 200 may include memory router 240. In operation, memory router 240 receives composite intensity value 231 from composite intensity module 230 and the OVI card 206 generated by orchestration layer 205. The OVI card 206 comprises the interaction content of the current turn (including user input and LLM response) along with a storage suggestion proposed by the base LLM. Memory router 240 processes these inputs through an adjudication process that evaluates at least an intensity floor determination based on the composite intensity value, a novelty determination relative to existing memory records (e.g., via embedding similarity), and application of a trust gate derived from SREA vector 220. Based on this adjudication, memory router 240 selects an appropriate storage target from among a plurality of governed memory tiers and outputs a routing decision 241 that directs a derived memory record to the corresponding portion of governed memory 250. In this manner, memory router 240 acts as an intelligent gatekeeper that enables selective, affectively governed memory storage rather than indiscriminate retention of all interactions. In one or more embodiments, the intensity floor determination is relaxed during a cold-start period when governed memory 250 contains fewer than a predetermined number of memory records, thereby allowing initial interactions to be stored more readily until sufficient history has been accumulated. OVI card 206 may include the full interaction content (user input and LLM response), the base LLM's storage suggestion, signed composite intensity, primary emotion label with confidence score, one or more contextual tags, and metadata sufficient for downstream adjudication and prompt enrichment. In one or more embodiments, the intensity floor determination applied by memory router 240 is relaxed during an initial cold-start period when governed memory 250 contains fewer than a predetermined number of memory records. The inner workings of memory router's 240 adjudication logic and the tiered lifecycle policies of governed memory 250 are described in more detail below with reference to FIG. 5.

AVA system 200 may include governed memory 250. In operation, governed memory 250 receives routed memory records 241 from memory router 240, each record derived from an OVI card 206 and enriched with emotional metadata such as signed intensity, emotion label, tags, storage target, timestamps, recurrence count, and an embedding for vector-based retrieval. Unlike conventional LLMs, which typically rely on a fixed context window and treat all tokens with equal weight (leading to rapid forgetting of important details, noisy retrieval, and inability to maintain long-term affective continuity), governed memory 250 applies intelligent, tier-specific lifecycle policies across multiple storage tiers (e.g., Long-Term, Short-Term, Discard, SOP/Best Practice, and Detail-Linked). These policies include decay, eviction, promotion between tiers, chain updates for superseding records, and echo-biased recall that prioritizes memories aligned with the current SREA vector 220 state. By governing memory in this affective and relational manner, AVA system 200 achieves persistent, emotionally coherent behavior across interactions and sessions, selectively retains high-significance experiences, forgets low-relevance noise, and enables more natural, trustworthy, and contextually aware responses, capabilities that conventional LLMs fundamentally lack due to their stateless, uniform context-window architecture. The SOP/Best Practice tier is restricted to error-handling procedures and reusable operational patches and is not used for general user interaction content. The detailed operation of memory router 240 adjudication logic and the specific tiered lifecycle policies, decay mechanisms, and recall strategies of governed memory 250 are described in more detail below with reference to FIG. 5.

AVA system 200 may include relational trust scoring module 260. In operation, relational trust scoring module 260 receives inputs from SREA vector 220 (providing the current affective state), accumulated interaction history stored in governed memory 250, observed consistency of behavior across multiple turns, and valence alignment between the current emotional state and recalled emotional states from governed memory 250, to compute and maintain a persistent relational trust score 261, that is typically normalized having a value in the range of [0.0, 1.0] with 0.5 defined as the neutral value. This score 261 quantifies the system's ongoing assessment of relational safety, reliability, and closeness with the user or entity. Relational trust score 261 may then be used as a dynamic gating mechanism that can force high-intensity records from Long-Term memory records to Short-Term storage, trigger safety circuit breakers, or modulate prompt construction toward more cautious or protective responses, when trust is low. By maintaining a persistent, affectively informed trust metric 261 separate from the base LLM, AVA system 200 enables consistent, relationship-aware behavior over long conversations, avoiding the erratic or overly sycophantic responses common in conventional LLMs that lack any internal model of relational history or trust trajectory. The detailed computation, update rules, and specific uses of the relational trust score 261 in gating and decision-making are described in more detail below with reference to FIG. 5.

AVA system 200 may optionally include safety and circuit breaker module 270. In operation, safety and circuit breaker module 270 receives inputs from SREA vector 220 (particularly elevated fear or negative valence), relational trust score 261, current and recalled interaction content, and composite intensity 231. Safety and circuit breaker module 270 continuously monitors the persistent affective and relational state for safety-relevant patterns. In one or more embodiments, the circuit breaker is configured to detect pathological trajectories such as sustained high fear, for example when the fear dimension of SREA vector 220 remains above a configurable predetermined threshold (such as approximately 0.65) across multiple consecutive turns, combined with collapsed relational trust, for example when the trust score falls below a configurable predetermined threshold (such as approximately 0.25-0.30). The module 270 may also consider composite intensity and the emotional valence of both current input and recalled memories when evaluating whether a safety threshold has been exceeded.

When safety and circuit breaker 270 activates, it may trigger one or more protective responses. These responses can include interrupting or modifying normal response generation, applying valence dampening to reduce the influence of negatively valenced recalled memories that conflict with the current emotional state, restricting the storage of new memory records into long-term governed memory, or limiting the recall of certain high-intensity or negatively valenced memories during prompt construction. Safety and circuit breaker 270 may also initiate redemption mechanisms that accelerate recovery of SREA vector 220 and relational trust score following a subsequent interaction that exhibits positive valence. For example, after a positive turn is detected, the system may apply an increased reinforcement rate or reduced decay to the trust and affection dimensions, allowing the affective state to recover more rapidly than under normal decay and reinforcement rules.

In addition, activation of the circuit breaker may cause the orchestration layer to route the current interaction for human-in-the-loop escalation before finalizing storage decisions or generating a response to the user. Safety and circuit breaker module 270 operates as part of the closed affective control loop and communicates with memory router 240 and prompt constructor 290. When breaker 270 is active, it can influence the storage target selected by memory router 240 (for example, forcing a high-intensity record into Short-Term rather than Long-Term storage) and can cause prompt constructor 290 to inject protective guidance or suppress certain memory injections. Threshold values, sensitivity parameters, and the specific combination of conditions that trigger breaker 270 are configurable according to the requirements of a particular application or deployment environment.

This safety-relevant gating provides a persistent, affectively informed safeguard that conventional LLMs lack. Conventional systems typically rely on stateless, prompt-level filters that cannot track long-term emotional trajectories, detect sustained patterns across multiple turns, or apply coordinated interventions across memory governance and response generation. By contrast, circuit breaker 270 uses the persistent SREA vector 220 and relational trust score 261 to identify emerging harmful patterns and to coordinate protective actions across memory routing 240, prompt construction 290, and response modulation.

AVA system 200 may optionally include human-in-the-loop escalation module 280. In operation, human-in-the-loop escalation module 280 receives triggers from safety and circuit breaker module 270. The escalation module 280 may also receive direct triggers based on high-risk combinations of the current SREA vector 220 state, relational trust score 261, and composite intensity 231. In one or more embodiments, escalation is initiated when the circuit breaker 270 has activated due to a detected pathological pattern, such as sustained high fear combined with collapsed trust over multiple turns. Escalation 280 may also be triggered directly when the fear dimension of SREA vector 220 exceeds a configurable predetermined high threshold while the trust score 261 simultaneously falls below a configurable predetermined low threshold, even if circuit breaker 270 has not yet activated. The module 280 evaluates these conditions on each turn as part of the closed affective control loop.

When human-in-the-loop escalation 280 is triggered, the current interaction is held for human review before the system 200 finalizes any storage decision or generates a response to the user. The escalation module 280 may present to a human operator relevant context, including the current SREA vector 220 state, the recent trajectory of fear and trust dimensions, relational trust score 261, composite intensity 231 of the current interaction, and one or more proposed memory records or storage decisions generated by memory router 240. The human operator may then review the presented information and provide confirmation, modification, or rejection of the proposed storage decision. The human may also direct that a modified or alternative response be generated, or that the interaction be handled according to specific safety protocols. After receiving human input, the system 200 may proceed with storage, generate a response, or take other actions consistent with the human operator's instructions.

The human-in-the-loop escalation module 280 integrates with orchestration layer 205, memory router 240, and prompt constructor 290. When escalation 280 is active, orchestration layer 205 may pause normal autonomous operation and route control to the escalation module 280. Memory router 240 may be instructed to hold or redirect storage of the current interaction pending human review. Prompt constructor 290 may be directed to withhold generation of a final response to the user until human input is received. This design allows AVA system 200 to maintain autonomous operation for routine interactions while ensuring that high-risk or ambiguous safety-relevant situations receive appropriate human oversight.

By tying escalation decisions to the persistent multi-dimensional affective state and relational trust trajectory rather than relying solely on keyword matching or static content filters, AVA system 200 achieves more nuanced and context-aware safety behavior. Conventional systems that use only prompt-level or keyword-based detection often either over-escalate benign interactions or fail to detect subtle, developing emotional spirals that emerge over multiple turns, interactions, or sessions. The human-in-the-loop 280 capability of AVA system 200 leverages the same persistent affective governance mechanisms used for memory routing and response modulation, thereby providing coordinated safety intervention across the entire closed control loop.

AVA system 200 may include prompt constructor 290. Prompt constructor 290, directed by orchestration layer 205, receives as inputs the current SREA vector 220 (providing the persistent multi-dimensional affective state), a set of echo-biased recalled memories retrieved and re-ranked from governed memory 250 based on affective alignment with the current SREA vector 220 dimensions, the current relational trust score 261, optional safety guidance or circuit breaker outputs from module 270, the raw or processed user input, and any task-specific context.

The detailed assembly logic proceeds as follows: memory selection and injection strategies prioritize the top-N most affectively aligned memories (using semantic similarity followed by SREA-dimension echo bias scoring), which are then formatted as concise, tagged context blocks (e.g., “[Prior Interaction—High Positive Valence]: User described successful collaboration; intensity 0.85”). Prompt templating combines these with a system-level summary of the current SREA vector 220 state (e.g., “System affective state: moderate fear with rising curiosity and trust level 0.62”), relational trust cues, and any active safety guidance strings. The full prompt is packaged as a structured chat-completion format, typically an ordered list of message objects with clear “system”, “user”, and “assistant” roles, including metadata tags for emotional context and returned to the base LLM (e.g., 100 of FIG. 1) prior to the model's tokenizer (e.g., 120 of FIG. 1). This pre-tokenizer delivery ensures the base LLM processes the complete affective, relational, and safety-enriched context through its standard pipeline, without modification to its weights.

Parameter modulation rules dynamically adjust generation settings based on the current state: for example, temperature is lowered (e.g., 0.7) in high-trust/high-affection scenarios to promote focused and supportive responses, raised (e.g., 1.1) under high-curiosity conditions to encourage exploratory ideas, and logit bias is applied to favor emotionally congruent language (e.g., warmer vocabulary when affection is elevated).

For purposes of illustration, consider a user message expressing worry about a project deadline while showing tentative excitement. Prompt constructor 290 might receive: SREA vector 220 with elevated fear (0.65) and moderate curiosity (0.58), trust score (0.62), two recalled memories (one positive collaboration, one past delay), and safety guidance “remain supportive.” It would assemble a prompt containing: (1) a system message with SREA summary and trust cues, (2) the current user message, (3) the two relevant memories formatted with emotional tags, (4) safety guidance, and (5) generation settings (temperature (0.85), bias toward solution-oriented language). This packaged prompt 295 is passed to the LLM prior to tokenization, enabling a modulated response 172 that acknowledges the worry, recalls the positive collaboration, offers proactive help, and maintains emotional coherence.

This prompt construction approach enables AVA system 200 to produce consistent, emotionally coherent, relationship-aware, and safety-sensitive responses over long conversations and across interactions and sessions, capabilities that conventional LLMs fundamentally lack due to their reliance on flat, stateless context windows that cannot maintain persistent affective memory, dynamically re-rank and tag memories by emotional resonance, or steer generation parameters based on long-term relational trust and trajectory monitoring.

AVA system 200 further includes orchestration layer 205, which serves as the central coordinating component directing data flow and control signals across modules on each turn. In operation, orchestration layer 205 receives intercepted raw user input 212 and sequences the following operations on each turn: (1) sending the input to emotion classifier 400 to obtain a label and confidence score; (2) updating the persistent SREA vector 220 with the new emotional data, applying decay to all dimensions toward neutral and reinforcement to relevant dimensions based on label and confidence; (3) computing composite intensity 231 from classifier confidence, echo/resonance from prior memories, decay, and SREA-modulated valence; (4) passing the composite intensity and OVI card 206 to memory router 240 for adjudication; (5) evaluating relational trust 261 and optional safety conditions 271, 281; and (6) directing prompt constructor 290 to assemble the enriched prompt 295 for the base LLM. Orchestration layer 205 maintains a turn-by-turn loop state that persists the updated SREA vector 220, trust score 261, governed memory 250 changes, and other session context into the next interaction, thereby closing the affective control loop. Note that FIG. 3 provides a high-level overview of the orchestration layer's 205 role and does not illustrate every input, output, or internal signal; additional interfaces and feedback loops, including the Rosetta measurement, are described in the accompanying text. By providing this model-agnostic coordination layer 205, AVA system 200 achieves persistent, affectively governed behavior without modifying the underlying LLM weights, a capability absent in conventional LLM architectures that lack any centralized affective orchestration.

AVA system 200 may optionally include Rosetta measurement module 284. Rosetta measurement module 284 receives two parallel proposals for each turn/interaction: (1) the storage suggestion generated by the base LLM and contained within OVI card 206, and (2) the independent storage decision produced by memory router 240 after performing intensity floor determination, novelty assessment via embedding similarity, and trust gating. Rosetta measurement module 284 compares these two proposals on a per-interaction basis and computes an agreement metric 285, typically expressed as a running agreement rate or accuracy percentage (e.g., number of matching decisions divided by total interactions over a rolling window). This Rosetta measurement 285 serves as a quantitative feedback signal that tracks how well the base LLM's (e.g., 100 of FIG. 2) implicit judgment of interaction importance aligns with AVA system's 200 affectively governed adjudication. High agreement indicates improving convergence between the LLM (e.g., 100 of FIG. 2) and the affective 200 control layer, while persistent discrepancies can be used to refine intensity calculations 230, trust scoring 260, storage policies 240, 250, prompt construction 290, or other system parameters over time. By maintaining this independent cross-check between model (e.g., 100 of FIG. 2) proposal and AVA system 200 decision, Rosetta measurement 285 provides auditability, measurability, and a mechanism for ongoing self-improvement of the affective governance process. This capability is absent in conventional LLMs, which have no external, affectively informed engine against which to compare their internal memory or salience judgments.

FIG. 4 is a schematic block diagram illustrating SREA vector 220 of an AVA system (e.g., 200 of FIG. 3) in accordance with one or more embodiments of the present invention. SREA vector 220 provides a persistent, multi-dimensional representation of the AVA system's 200 affective state that evolves over time and across interactions. In one or more embodiments, SREA vector 220 comprises at least three core dimensions, trust, fear, and curiosity, and may optionally include additional dimensions such as affection, longing, and protectiveness. Each dimension is maintained as a normalized floating-point value in the range [0.0, 1.0], where a value of 0.5 represents a neutral baseline for that dimension (neither strongly present nor absent). Values approaching 1.0 indicate that the affective dimension is strongly present or highly activated in the current state of the system. Values approaching 0.0 indicate that the affective dimension is largely absent or strongly suppressed relative to the neutral baseline. This normalized representation allows the system 200 to maintain a coherent, quantitative model of its internal emotional posture that can be directly used for downstream computations such as composite intensity, memory routing, trust gating, and prompt modulation.

SREA vector 220 may be updated on each turn based on emotional classification data 410 received from emotion classifier 400. In one or more embodiments, emotion classifier 400 outputs 410 a distribution of probabilities (or confidence scores) across a set of emotion categories, which may include, for example, anger, disgust, fear, joy, neutral, sadness, and surprise. These outputs are mapped to updates in the relevant SREA vector 220 dimensions through a two-phase process of decay and reinforcement. First, each dimension of SREA vector 220 is decayed toward the neutral value of (0.5) according to a configurable decay factor (typically on the order of 0.98). The decay operation may be expressed as: new_value=old_value*decay_factor+0.5*(1−decay_factor). This gradual drift toward neutrality prevents any single past interaction from permanently dominating the affective state and allows the system's “mood” to naturally fade in the absence of reinforcing input.

Following decay, relevant SREA vector 220 dimensions receive reinforcement in the form of an additive delta computed from the classifier 400 output 410. Reinforcement for a given dimension may be calculated as: reinforcement_delta=classifier_confidence*learning_rate*valence_weight, where the learning rate is typically on the order of (0.05) and the valence weight reflects the semantic alignment between the classified emotion and the target SREA vector 220 dimension (which may be positive, negative, or zero). The resulting delta is then added to the decayed dimension value. Cross-dimension effects may also be applied, such that a strong joy signal may mildly boost affection or curiosity while simultaneously dampening fear. One of ordinary skill in the art, having the benefit of this disclosure, will appreciate that the specific mapping functions, weights, and which emotions influence which dimensions may be configured or learned differently across embodiments without departing from the scope of the present invention. For example, in some embodiments a valence-arousal-dominance (“VAD”) representation from the classifier may be mathematically projected onto the SREA vector 220 dimensions rather than using discrete emotion labels.

For purposes of illustration, consider an intercepted user input (e.g., 212 of FIG. 3) that triggers emotion classifier (e.g., 400 of FIG. 3) to output 410 primary fear label with confidence (0.72) and a secondary joy signal with confidence (0.45). Assume the current SREA vector 220 prior to update is: trust (0.58), fear (0.48), curiosity (0.55), affection (0.62), longing (0.51), and protectiveness (0.47). After applying decay (factor 0.98), the intermediate vector becomes approximately: trust (0.579), fear (0.480), curiosity (0.549), affection (0.619), longing (0.510), and protectiveness (0.470). Reinforcement is then applied. The fear dimension receives a delta of approximately +0.036(0.72*0.05*1.0). The curiosity dimension receives a delta of approximately +0.018 from the joy signal. The trust dimension receives a smaller positive delta of approximately +0.008 due to valence alignment. The resulting updated SREA vector 220 reflects a modest increase in fear and curiosity while preserving the overall affective posture of the system. The specific numerical values, learning rate, decay factor, and dimension-to-emotion mappings used in this example are illustrative; different values and mappings may be used in other embodiments while still operating within the scope of the invention. This updated vector 220 is then available for use in composite intensity calculation, memory routing, relational trust scoring, safety monitoring, and prompt construction.

In addition to fresh emotional classification data 410, SREA vector 220 may incorporate information from recalled memories 251 retrieved from governed memory 250. Recalled memories 251 that are affectively aligned with the current state (echo-biased recall) may contribute additional reinforcement or valence modulation to one or more vector 220 dimensions. For example, a strongly positive recalled memory 251 may increase affection or trust even in the absence of a current positive classifier signal, thereby maintaining relational continuity across turns and sessions. Other inputs, such as explicit user feedback, system-level policy signals, or safety circuit breaker outputs, may also influence SREA vector 220 updates in certain embodiments. The self-referential nature of SREA vector 220 means that its own prior state is always part of the update calculation, allowing the affective representation to evolve smoothly while retaining historical context.

Maintaining a persistent, multi-dimensional affective state via SREA vector 220 provides significant technical advantages over conventional LLM systems. Conventional LLMs lack any internal representation of emotional continuity and therefore cannot produce responses that are consistently sensitive to a user's evolving emotional trajectory or relational history. By contrast, SREA vector 220 enables AVA system 200 to (1) generate responses whose tone, content selection, and generation parameters are modulated by a coherent affective context, (2) make more intelligent, affectively informed decisions about what to remember or forget, (3) detect and respond appropriately to emotional escalation or safety-relevant conditions, and (4) maintain long-term relational trust and continuity across sessions. These capabilities result in measurably more coherent, trustworthy, and contextually appropriate behavior over extended interactions and sessions, outcomes that are difficult or impossible to achieve with stateless context-window architectures alone. The flexibility of the SREA representation (configurable dimensions, mapping functions, and update rules) further allows the system to be adapted to different application domains, user populations, or regulatory requirements without fundamental redesign.

FIG. 5 is a schematic block diagram illustrating memory router 240 adjudication engine and governed memory 250 of AVA system 200 in accordance with one or more embodiments of the present invention. Memory router 240 and governed memory 250 together provide an intelligent, affectively informed mechanism for deciding what information from turns/interactions should be retained, how it should be organized and maintained over time, and how it should be retrieved when relevant.

Memory router 240 receives as primary inputs OVI card 206 generated by orchestration layer 205, composite intensity value 231 from composite intensity module 230, output 221 of SREA vector module 220, and relational trust score 261 from relational trust scoring module 260. OVI card 206 contains the interaction content of the current turn (including user input and the LLM's response), a storage suggestion generated by the LLM, and one or more tags associated with the interaction. Memory router 240 performs an independent adjudication process that evaluates the interaction against multiple criteria and produces a routing decision 241 that selects one storage target from among a plurality of governed memory tiers, including Long-Term store 242, Short-Term store 243, Discard 244, SOP/Best Practice 245, and Detail-Linked store 246. The routed memory record is then passed via output 241 to governed memory 250.

In one or more embodiments, the adjudication performed by memory router 240 includes at least an intensity floor determination based on composite intensity value 231, a novelty determination relative to existing memory records (typically performed by generating an embedding of OVI card 206 content and computing cosine similarity), and a trust gate evaluation based on relational trust score 261 and SREA vector output 221. Memory router 240 may also apply a model-suggestion override, a type-validation redirect, or a default path acceptance. For example, even if the LLM's storage suggestion in OVI card 206 indicates that an interaction should be discarded, a high composite intensity value 231 combined with adequate novelty and sufficient relational trust score 261 may cause memory router 240 to override the LLM's suggestion and route the record to Long-Term store 242.

Once memory router 240 produces routing decision 241, it outputs a derived memory record to governed memory 250. Each memory record stored in governed memory 250 typically includes signed intensity, emotion label, or labels, one or more tags, the selected storage target, timestamps, a recurrence count, and an embedding vector suitable for similarity-based retrieval.

Governed memory 250 applies tier-specific lifecycle policies through its governance component 255. These policies include decay, eviction, promotion between tiers (for example, from Short-Term store 243 to Long-Term store 242), chain updates, and echo-biased recall. Governed memory 250 maintains records across hot store 252 (for fast access to recently used or high-priority records), vector index 253 (for similarity-based retrieval), and persistent store 254 (for long-term retention). When the system requires context, governed memory 250 performs echo-biased recall and provides relevant memory records via output 251 to prompt constructor 290.

In operation, memory router 240 and governed memory 250 may function as an independent affective governance layer that is separate and apart from the base LLM. While the LLM generates responses based on its internal parameters and the prompt it receives, it has no persistent affective state and no independent mechanism for evaluating the long-term emotional or relational significance of interactions. Memory router 240 and governed memory 250 operate externally to the LLM, receiving composite intensity value 231, OVI card 206, SREA vector output 221, and relational trust score 261, and producing independent routing decisions 241 and governed storage. This separation enables AVA system 200 to maintain long-term affective nuance, including emotional continuity across sessions, selective retention of high-significance experiences, echo-biased recall aligned with the current affective state, and protective handling when trust or safety conditions warrant, without requiring any modification to the underlying LLM. The independent decisions produced by memory router 240 also enable the Rosetta measurement, which compares the LLM's storage suggestion against the router's 240 adjudication to provide a quantitative feedback signal for ongoing system 200 refinement.

One of ordinary skill in the art, having the benefit of this disclosure, will recognize that one or more non-transitory computer-readable media may comprise software instructions that, when executed by a processor, may perform one or more of the above-noted methods in accordance with one or more embodiments of the present invention.

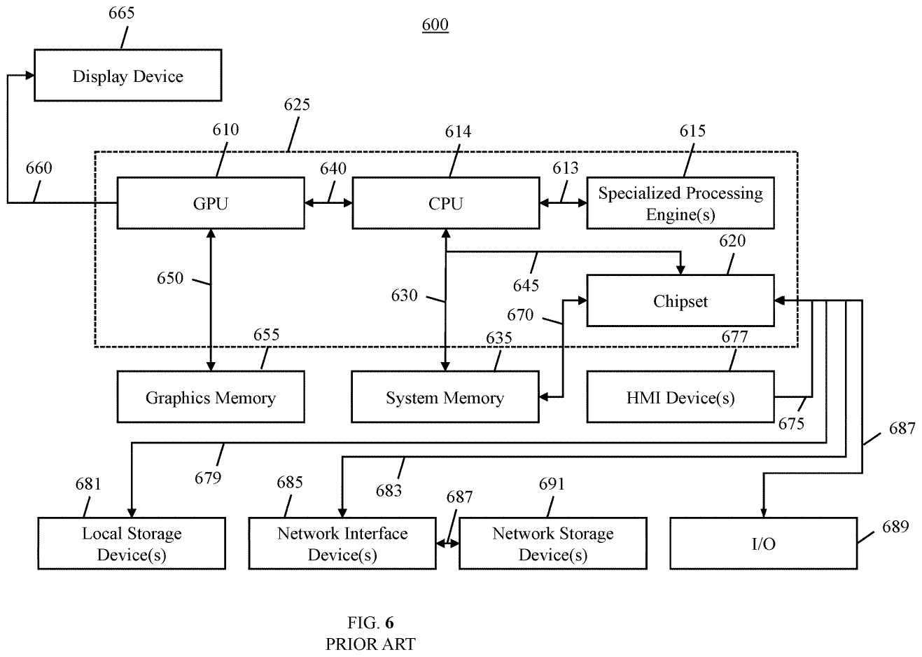

FIG. 6 is a schematic block diagram of a computing system 600 in accordance with one or more embodiments of the present invention. Computing system 600 may include one or more central processing units (“CPU”) 614, one or more graphics processing units (“GPU”) 610, and one or more specialized processing engines 615. Computing system 600 may optionally include, if not integrated into CPU 614, a chipset 620 that incorporates one or more functions previously provided by a legacy host bridge (not shown) or input/output (“I/O”) bridge (not shown). In certain embodiments, one or more of the above-noted components may be discrete components. In other embodiments, one or more of the above-noted components, or the functions that they implement, may be integrated into a system-on-chip (“SOC”). An SOC design may include a plurality of one or more of the above-noted components disposed on the same physical die (not shown) or disposed within the same mechanical package (not shown). One of ordinary skill in the art will recognize that the one or more CPUs 614, the one or more GPUs 610, the one or more specialized processing engines 615, and chipset 620 may be integrated, in whole or in part, to reduce the thermal design power (“TDP”), reduce power consumption, reduce chip count, reduce the mechanical footprint, and reduce the complexity of the printed circuit board (“PCB”) (not shown) that they may be disposed on.

Each of the one or more CPUs 614, the one or more GPUs 610, the one or more specialized processing engines 615, and chipset 620 may be a single-core processor (not independently illustrated) or a multi-core processor (not independently illustrated). Multi-core processors typically include a plurality of processor cores (not shown) disposed on the same physical die (not shown) or disposed within the same mechanical package (not shown) that are arranged to provide enhanced capabilities over a single-core implementation. Each of the one or more CPUs 614 may include a memory interface 630 to system memory 635, a graphics interface 650 to the one or more GPUs 610, a specialty interface 613 to the one or more specialized processing engines 615, and a chipset interface 645 to chipset 620. Each of the one or more GPUs 610 may include a CPU interface 640 to the one or more CPUs 614, a memory interface 650 to graphics memory 655, and a display interface 660 to a display device 665. Chipset 620 may include a chipset interface 645 to the one or more CPUs 614, a memory interface 670 to system memory 635, and one or more IO interfaces to one or more IO expansion devices, including, for example, a human/machine interface (“HMI”) interface 675 to one or more HMI devices 677, a local storage interface 679 to one or more local storage devices 681, a network interface 683 to one or more network interface devices 685, and other I/O interfaces 687 to one or more other I/O devices 691.

Each local storage device 681 may be a solid-state memory device, a solid-state memory device array, a hard disk drive, a hard disk drive array, or any other non-transitory computer readable medium. Computing system 600 may also include one or more network-attached storage devices 691 that communicate with one or more network interface devices 685 via a network interface 683. The one or more network-attached storage devices 691 may be used in addition to, or instead of, the one or more local storage devices 681. The one or more network-attached storage devices 691 may be a solid-state memory device, a solid-state memory device array, a hard disk drive, a hard disk drive array, or any other non-transitory computer readable medium. The one or more network-attached storage devices 691 may or may not be collocated with computing system 600 and may be accessible to computing system 600 via one or more network interfaces 683 provided by one or more network interface devices 685. Each network interface device 685 may provide one or more network interfaces including, for example, Ethernet, Fibre Channel, WiMAX, Wi-Fi, Bluetooth, or any other type or kind of network connectivity and network protocol suitable for networked communications.

Computing system 600 may also include one or more application specific integrated circuits (“ASICs”) that are configured to perform a certain function, such as, for example, hashing (not shown), in a more efficient manner. The one or more ASICs may interface directly with the one or more CPUs 614, the one or more GPUs 610, the one or more specialized processing engines 615, and chipset 620.

While computing system 600 has been described above as a general-purpose computing device, one of ordinary skill in the art will recognize that computing system 600 may be reduced to only those components necessary to perform a desired function or scaled up as needed to meet requirements. As such, any of the above-noted components, or various subsets, supersets, or combinations of functions or features thereof, may be integrated, in whole or in part, or distributed among various devices based on an application, design, or form factor in accordance with one or more embodiments of the present invention. As such, the description of computing system 600 is merely exemplary and not intended to limit the type, kind, or configuration of components that constitute a computing system suitable for performing computing operations.

In certain embodiments, computing system 600 may be implemented as a specialized industrial system, a server, a workstation, a desktop computer, a laptop computer, a netbook, a tablet, a smartphone, a mobile device, and/or any other type or kind of computing system in accordance with one or more embodiments of the present invention. In other embodiments, computing system 600 may be instantiated as a virtual computer (not shown) in a virtual or cloud-based infrastructure such as those provided by, for example, Amazon AWS®, Microsoft Azure®, Google Cloud®, or other cloud computing service providers. In such embodiments, the components of computing system 600 may be distributed in a manner that is transparent, but potentially unknown, to the end user. Advantageously, virtualization provides physical isolation, fault tolerance, redundancy, and automated backup mechanisms that protect the integrity of data stored therein.

One or more embodiments of the present invention offer several important technical advantages over conventional LLM systems.

In one or more embodiments, the invention enables persistent emotional continuity and relational awareness across interactions and sessions. By maintaining a multi-dimensional SREA vector that evolves through decay and reinforcement, the system preserves affective state and relational context over time, allowing it to respond with greater coherence and consistency than conventional systems that lack any persistent internal affective representation.

In one or more embodiments, the invention produces higher-quality memory storage decisions than those generated by the base LLM. An independent memory router evaluates each interaction using composite intensity, novelty via embedding similarity, and a trust gate, generating an engine storage decision that can be directly compared to the model's own suggestion through the Rosetta measurement. This provides a measurable and refinable basis for improved memory governance.

In one or more embodiments, the invention significantly reduces memory bloat while improving retrieval relevance. Governed memory applies tier-specific lifecycle policies, including decay, eviction, promotion, chain updates, and echo-biased recall aligned with the current affective state. This enables selective retention of high-value interactions and the systematic removal of low-relevance content.

In one or more embodiments, the invention supports genuine session-to-session continuity. The SREA vector, relational trust score, and governed memory records persist across separate sessions, enabling the system to maintain emotional and relational context with a user over extended periods rather than resetting between conversations.

In one or more embodiments, the invention provides affectively informed safety mechanisms that conventional systems lack. Trust-based gating and safety circuit breaker functionality can restrict storage or trigger human-in-the-loop review based on the persistent affective state and relational trust trajectory, rather than relying solely on stateless, prompt-level detection.

In one or more embodiments, the invention improves the quality of responses generated by an unmodified base LLM. Enriched prompts that incorporate the persistent affective state, selectively retrieved governed memories, and relational trust cues enable the base model to generate responses with greater emotional continuity, contextual coherence, and relational awareness over extended interactions.

In one or more embodiments, the present invention operates as model-agnostic middleware that enhances any unmodified base LLM. By constructing and delivering enriched prompts prior to tokenization, the system delivers improved emotional coherence, selective memory governance, and safety-aware behavior across a wide range of existing and future LLMs without requiring changes to model architecture or weights.

In one or more embodiments, the present invention offers important technical advantages over prior approaches to affective computing in artificial intelligence systems. For example, U.S. Patent Application Publication No. US2019/0236464A1 to Feinson et al. (hereinafter “EmergeX”) discloses systems and methods for facilitating affective-state-based artificial intelligence in which an artificial intelligence entity maintains a set of affective attributes with associated growth and decay factors, continuously updates those values, and generates responses based on the current affective state. While EmergeX describes multi-dimensional affective representations and self-modulating decay for AI characters, it does not teach or suggest the claimed independent memory router that performs intensity-based adjudication with novelty determination and trust gating, the tier-specific governed memory stores with echo-biased recall aligned to a persistent SREA vector, the Rosetta measurement comparing model-proposed storage decisions against engine adjudication, or the model-agnostic middleware architecture that enriches prompts for an unmodified base large language model to achieve long-term emotional continuity and relational awareness across sessions.

Similarly, PCT International Application Publication No. WO2024/242017A1 to Son et al. (hereinafter “SoftBank”) describes a control system for an electronic apparatus that switches between recording formats and adjusts retention periods based on whether the emotion of the apparatus or user exceeds a threshold. While SoftBank addresses emotion-influenced storage tiering and retention in a sensor/recording context, it does not disclose or suggest the claimed persistent multi-dimensional SREA vector as a unified control signal, composite intensity computation for interaction adjudication, independent memory router with novelty and trust gate mechanisms, echo-biased recall for prompt construction, or integration as middleware with large language models to provide governed, affectively informed memory management that reduces bloat while preserving contextual coherence over extended interactions.

By contrast, the AVA system of the present invention integrates a persistent, evolving SREA vector with intensity-gated memory routing, governed lifecycle policies, and affectively biased recall into a closed-loop, model-agnostic system. This combination enables technically superior session-to-session continuity, selective high-significance retention, and emotionally coherent responses, outcomes difficult or impossible to achieve with the prior approaches operating in disparate domains and without the claimed unified affective-memory governance loop.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should only be limited by the appended claims.

1. A method of persistent multi-dimensional affective state management with emotion-biased memory routing in an Affective Vector Architecture (AVA) system for a large language model (LLM), the method comprising:
maintaining a persistent Self-Referential Emotion Anchor (SREA) vector that represents an affective state across a plurality of interactions and sessions;
generating a composite intensity value for a current turn, wherein the composite intensity value is derived at least in part from the SREA vector;
constructing, by an orchestration layer, an Object-Verified Interaction (OVI) card from a response generated by the LLM, wherein the OVI card comprises interaction content of the current turn and a storage suggestion generated by the LLM;
providing the composite intensity value and the OVI card to a memory router;
performing, by the memory router, an adjudication of the OVI card, wherein the adjudication comprises at least an intensity floor determination based on the composite intensity value, a novelty determination relative to existing memory records, and application of a trust gate derived from the SREA vector to select a storage target from among a plurality of storage targets; and
routing a memory record derived from the OVI card to a governed memory store corresponding to the selected storage target, wherein the governed memory store applies a tier-specific lifecycle policy to the memory record, the tier-specific lifecycle policy including at least one of decay, eviction, or echo-biased recall.

2. The method of claim 1, wherein the echo-biased recall first retrieves candidate memory records by semantic similarity and then re-ranks them by scalar alignment of each candidate's emotion label with the current values of the SREA vector dimensions, whereby memories emotionally congruent with the present affective state are preferentially surfaced even if their semantic similarity is lower.

3. The method of claim 1, further comprising comparing the storage suggestion generated by the LLM (as contained in the OVI card) with the storage target selected by the memory router to produce a Rosetta measurement and using the Rosetta measurement to refine at least one of future intensity calculations, trust scoring, or storage policies of the AVA system.

4. The method of claim 1, wherein when the storage suggestion generated by the LLM indicates that the interaction should not be stored and the composite intensity value meets or exceeds a resonance override threshold, the memory router overrides the storage suggestion and selects a storage target.

5. The method of claim 1, further comprising persisting the updated SREA vector, governed memory records, and relational trust score into the next turn to form a closed-loop control architecture that provides genuine session-to-session emotional and relational continuity.

6. The method of claim 1, wherein the AVA system constructs enriched prompts incorporating the persistent affective state and selectively retrieved governed memories and delivers the prompts to the LLM without ever altering the weights or parameters of the LLM.

7. The method of claim 1, wherein the adjudication performed by the memory router further comprises at least one of a model-suggestion override, a type-validation redirect, or a default path acceptance after performing the intensity floor determination, novelty determination, and trust gate.

8. The method of claim 1, wherein the trust gate derived from the SREA vector forces a Long-Term storage target down to a Short-Term storage target when a trust score falls below a predetermined threshold.

9. The method of claim 1, wherein the memory router performs adjudication to generate an engine storage decision that is independent of and may differ from the storage suggestion generated by the LLM and contained in the OVI card, thereby enabling a direct comparison between the model proposal and the engine decision.

10. The method of claim 1, wherein the novelty determination comprises embedding content of the OVI card and comparing cosine similarity to existing memory records, wherein low novelty results in discard or echo-count increment.

11. The method of claim 1, wherein the memory router performs adjudication to select the storage target independently of lifecycle management performed by the governed memory store, the governed memory store separately managing at least decay, eviction, and echo-biased recall of stored memory records.

12. The method of claim 1, wherein the OVI card further comprises one or more tags associated with the interaction content.

13. The method of claim 1, wherein the plurality of storage targets includes at least Long-Term, Short-Term, Discard, SOP/Best Practice, and Detail-Linked.

14. The method of claim 1, wherein the SOP/Best Practice storage target is restricted to error procedures or reusable operational patches.

15. The method of claim 1, further comprising:
performing a chain update in which a new memory record supersedes a prior memory record while maintaining linkage to the prior record.

16. The method of claim 1, wherein the composite intensity value is generated from at least two of: classifier confidence, echo/resonance, decay, and valence modulation.

17. The method of claim 1, wherein the tier-specific lifecycle policy includes echo-biased recall that prioritizes memories with higher recurrence counts.

18. The method of claim 1, wherein the orchestration layer is model-agnostic and capable of operating with any one of a plurality of different base LLMs.

19. The method of claim 1, wherein the memory router selectively routes only a subset of interactions to the governed memory store based on the adjudication, rather than storing all interactions for later semantic retrieval.

20. The method of claim 1, wherein each memory record stored in the governed memory store includes at least signed intensity, emotion label, tags, storage target, timestamps, recurrence count, and an embedding for vector search.

21. The method of claim 1, wherein the intensity floor determination is relaxed during a cold-start period when the governed memory store contains fewer than a predetermined number of memory records.

22. The method of claim 1, further comprising:
intercepting raw user input prior to processing by the large language model;
sending the raw user input to an emotion classifier; and
updating the SREA vector based on an output of the emotion classifier.

23. The method of claim 1, further comprising:
constructing, by a prompt constructor directed by the orchestration layer, a prompt that incorporates at least one memory record retrieved from the governed memory store and sending the prompt to the LLM.

24. The method of claim 1, further comprising:
applying a safety circuit breaker that monitors at least one of intensity level, trust score, or content classification and prevents storage or recall of a memory record when a safety threshold is exceeded.

25. The method of claim 1, further comprising:
presenting at least one proposed memory record or storage decision to a human operator for review and receiving confirmation or modification from the human operator before finalizing storage in the governed memory store.

26. A non-transitory computer-readable medium storing instructions that, when executed by one or more processors, causes the one or more processors to perform the method of claim 1.

27. A system for persistent multi-dimensional affective state management with emotion-biased memory routing in an AVA, comprising: one or more processors; and memory storing instructions that, when executed by the one or more processors, cause the system to perform the method of claim 1.

28. A method of persistent multi-dimensional affective state management with emotion-biased memory routing in an AVA system for a large language model, the method comprising:
maintaining a persistent Self-Referential Emotion Anchor (SREA) vector that represents an affective state across a plurality of interactions and sessions;
generating a composite intensity value for a current turn, wherein the composite intensity value is derived at least in part from the SREA vector;
providing the composite intensity value to a memory router;
performing, by the memory router, adjudication based on the composite intensity value to select a storage target;
routing a memory record to a governed memory store corresponding to the selected storage target, wherein the governed memory store applies a tier-specific lifecycle policy to the memory record, the tier-specific lifecycle policy including echo-biased recall; and
constructing an enriched prompt incorporating the persistent SREA vector and selected memory records for delivery to a large language model, wherein the AVA system persists the updated affective state and memory records to enable adaptive, emotionally coherent responses across interactions or sessions.
